(19) United States
(12) Patent Application Publication
(10) Pub. No.: US 2024/0203613 A1
(43) Pub. Date: Jun. 20, 2024

(54) MOLTEN SALT NUCLEAR REACTOR, OF FAST NEUTRON TYPE, THE PRIMARY CIRCUIT OF WHICH CIRCULATES BY NATURAL CONVECTION

(71) Applicant: COMMISSARIAT A L'ENERGIE ATOMIQUE ET AUX ENERGIES ALTERNATIVES, Paris (FR)

(72) Inventors: Guillaume CAMPIONI, Paris (FR); Antoine GERSCHENFELD, Montrouge (FR); Vincent PASCAL, Vinon Sur Verdon (FR); Yannick GORSSE, Gif Sur Yvette (FR)

(73) Assignee: COMMISSARIAT A L'ENERGIE ATOMIQUE ET AUX ENERGIES ALTERNATIVES, Paris (FR)

(21) Appl. No.: 18/542,987

(22) Filed: Dec. 18, 2023

(30) Foreign Application Priority Data
Dec. 19, 2022 (FR) 22 13882

(51) Int. Cl. G21C 3/54; G21C 1/02; G21C 11/06; G21C 19/40

(52) U.S. Cl. CPC G21C 3/54; G21C 1/02; G21C 11/06; G21C 19/40

(57) ABSTRACT

A molten salt nuclear reactor of the fast neutron reactor type may be designed as a reactor vessel free of moderator or at the very least of a moderator enabling a reactor to be qualified as a thermal neutron reactor, having a shape exhibiting symmetry of revolution surrounded by another vessel at the periphery of the reactor vessel thereby delimiting a guard gap filled with an inert liquid salt which acts as a coolant for removing the decay heat from the reactor by conduction through the reactor vessel.

### TECHNICAL FIELD

The present invention relates to the field of molten salt nuclear reactors (“Molten Salt Reactor”, of acronym MSR). More particularly, it relates to the field of the so-called low or average power MSR reactors, or AMR (acronym for “Advanced Modular Reactor”).

The main objective of the invention is thus to simplify the architecture of the primary circuit of such reactors, more particularly the fast neutron reactors.

The expression “molten salt reactor” is understood here, and in the context of the invention, by its usual technological meaning, namely a nuclear reactor in which the nuclear fuel is in liquid form, dissolved in a molten salt, at a temperature typically of between 500 and 900° C., which acts as coolant.

### PRIOR ART

Molten salt reactors rely on the use of a molten salt, for example lithium fluoride (LiF) and beryllium fluoride (BeF2) or even sodium chloride (NaCl) and magnesium chloride (MgCl₂), serving both as coolant fluid and as moderator as primary fluid in the reactor tank, which is metal or ceramic, typically made of SiC.

The tank contains the molten salt at high temperature, typically between 500 and 900° C., generally at ambient pressure.

The fissile fuel can be uranium 235, plutonium or even uranium 233, the latter then being derived from the conversion of thorium. A molten salt reactor can itself handle its breeder function using a fertile cover containing the fertile isotope to be irradiated.

The nuclear reaction is triggered by the fissile material concentration of the fuel in the reactor tank or by passage through a graphite moderator block.

A molten salt reactor can therefore be moderated by graphite, producing thermal neutrons, or without moderator producing fast neutrons.

The presence or otherwise of moderators thus defines the two major families of molten salt reactors, respectively thermal neutron reactors and fast neutron reactors.

Since the beginning of the 2000s, molten salt reactors have been assessed, then retained in the context of the Generation IV International Forum. They are now the subject of international research with a view to deployment as fourth-generation reactors, notably as small modular reactors (SMR) which are advanced nuclear reactors (acronym AMR), the power capacity of which can range up to 300 MWe per unit.

Although promising in terms of safety potential, molten salt reactors can require costly and complex systems and components.

Indeed, in a molten salt reactor, the primary fuel circuit, containing dissolved uranium or plutonium, constitutes the first safety barrier, and must therefore meet design criteria that are very demanding in terms of seal-tightness. This primary circuit must comprise a so-called core zone, in which the nuclear fission reactions are strung together and a heat exchange zone fluidically linked to the core, in which the heat generated in the core is transmitted to a secondary circuit.

In the conventional designs, the core is linked to a plurality of fluid circulation loops each comprising an exchanger and a pump suitable for ensuring the circulation from and to the associated exchanger.

For example, among the programs retained for the Generation IV, the homogeneous indirect cooling reactor derived from the research of the LPSC laboratory in Grenoble, which is referred to by the acronym MSFR (for “Molten Salt Fast Reactor”), the fuel of which is a liquid fluorinated salt with breeding ensured by the thorium, comprises some twelve or sixteen fluid circulation loops. Each of the components of the loops adds complexity to the fluidic circuit as a whole: [1]

For the design of a molten salt reactor, in particular of SMR type, the inventors have sought to develop a design that minimises the number of ducts and components, notably to retain the major advantage inherent to the SMRs, namely the enhanced capacity for modularity by factory-manufacturing of the components for transportation to the construction site, and also to increase dependability.

The patent application WO2018213669 A2 describes a fluoride salt and molten thorium/uranium fuel reactor, of thermal neutron type, in which the primary circuit circulates by natural convection. The proposed architecture cannot be duplicated to a fast neutron type reactor.

There is therefore a need to enhance the reactors of molten salt type, of fast neutron type, notably when they are considered as AMR reactors, in order to mitigate the drawbacks described above, more particularly to have a reactor tank in module form, that can be manufactured in a standard manner in a factory and that is easily transportable.

The aim of the invention is therefore to at least partly address this need.

### SUMMARY OF THE INVENTION

To do this, the invention relates, in one of its aspects, to a molten salt nuclear reactor, of fast neutron type, comprising:
a reactor tank that is axisymmetrical about a central axis, internally delimiting a primary circuit of fuel in liquid form in which at least one salt is molten, the interior of the tank being stripped of a moderator material;
a lid cap closing the reactor tank;
at least one heat exchanger between the primary circuit of the reactor and a secondary circuit, arranged inside the reactor tank;
a first shell in the form of at least one hollow cylinder, with a central axis that coincides with that of the reactor tank, the first shell being arranged in the reactor tank to separate the interior thereof into a central zone and a peripheral zone in which the heat exchanger is arranged such that, when the reactor is operating, the molten salt fuel liquid circulates by natural convection according to a loop from the bottom of the central zone defining the reactor core in which the fission reactions take place, from which it rises by heating to the top of the central zone where it is deflected to the top of the peripheral zone to pass through the exchanger then descends to the bottom of the peripheral zone where it is deflected to the core of the reactor.

In the context of the invention, the lid cap of the core can be supported or fully formed with the closure slab of the reactor forming the top part of the tank well.

In the context of the invention, the expression “stripped of moderator material” is understood to mean any material which makes it possible to qualify a nuclear reactor as being a thermal neutron nuclear reactor. In the normal sense, the kinetic energy of a fast neutron is greater than 1 eV, whereas that of a thermal neutron is less than 1 eV, typically of the order of 0.025 eV. Reference will be able to be made to the publication [2], and in particular FIG. 4, which indicates, for several types of reactors, the thermal fraction and the fast fraction of the neutron flux.

Thus, a molten salt reactor according to the invention is qualified as fast neutron.

Typically, a molten salt reactor according to the invention can have a thermal neutron fraction of 0 to 0.05 and a fast fraction of 0.6 to 0.65.

According to an advantageous embodiment, the nuclear reactor comprises a second shell arranged concentrically inside the first shell, so as to guide the fuel liquid which rises between the two zones where it is deflected.

According to this embodiment, the interior of the second shell advantageously defines a space in which nuclear reaction control and/or safety bars extend. In other words, this second shell forms an open-ended column arranged coaxially inside the first shell and at the centre of the reactor tank. This central column advantageously makes it possible to orient the ascending fuel liquid thus guided in the annular space between first and second shells, and to form a location for control and/or safety bars.

Preferably, the outer diameter of the second shell is between 5 and 30% of the inner diameter of the first shell.

More preferably, the first shell and, if appropriate, the second shell, is or are fixed by suspension from the lid cap closing the reactor tank. The material of the first shell and, if appropriate, the second shell, is preferably chosen from among a stainless steel or a nickel-based alloy.

According to another advantageous embodiment, the reactor comprises at least one deflector, preferably in the form of a torus portion, arranged below and/or above the first shell so as to distribute the flowrate of the deflected molten salt fuel liquid. In other words, this or these toroidal deflector or deflectors make it possible to optimise the distribution of the flowrate of the fuel liquid within the reactor tank. The material of the deflector or deflectors is or are preferably chosen from among a stainless steel or a nickel-based alloy.

According to an advantageous variant embodiment, the thickness of the part of the first shell arranged above the exchanger or exchangers is greater than that of its part arranged below the exchanger or exchangers. Having a reduced thickness in the bottom of the reactor tank makes it possible to maximise the volume of fuel salt and to allow the chain nuclear reactions to take place, this reduced thickness thus delimiting the core of the reactor.

Advantageously, the thickness of the part of the first shell arranged above the exchanger or exchangers is greater by between 3 and 100% than that of its part arranged below the exchanger or exchangers.

According to another advantageous embodiment, the reactor tank comprises a plenum, usually called cover-gas plenum, filled with an inert gas, such as argon or even helium, above the molten salt fuel liquid. This plenum makes it possible on the one hand to absorb the thermal expansion of the fuel salt liquid in the reactor tank, when it undergoes a level variation and on the other hand to recover the gaseous fission products generated by the nuclear fissions in the fuel salt.

According to an advantageous construction variant, the heat exchanger or exchangers comprises or comprise a bundle of tubes, of bayonet tube type, with hollow tubes each emerging inside a blind tube, defining the part enabling exchange with the secondary circuit, dipped substantially vertically at least partially in the molten salt fuel liquid, the emerging hollow tubes being linked to an input manifold and the blind tubes being linked to an output manifold for the secondary fluid.

Advantageously, the secondary fluid input and output manifolds are arranged in the cover-gas plenum. With such an arrangement, a direct contact is avoided between these manifolds and the salt of the primary circuit, which increases their lifetime as well as the safety of operation of the exchangers, since the only part immersed remains a part of the height of the bundle of tubes. The nuclear reactor can have one and/or other of the following dimensional features for a power typically of 150 MWth:
the diameter of the reactor tank is between 1.5 and 2 m;
the height of the primary circuit inside the reactor tank is between 2.5 and 4 m.

Preferably, the molten salt fuel liquid of the primary circuit is chosen from among a mixture of NaCl—UCl₃, preferably in proportions of 25 to 30% mol for the UCl₃, and PuCl₃, preferably in proportions of 5 to 36% mol, as salts, with depleted uranium U235, preferably less than 0.3%, atomic, or a mixture of NaCl—UCl₃, preferably to 34% mol, as salt with enriched uranium U235 (HALEU), preferably in proportions of 5 to 20%.

When the reactor is in operation, the temperature of the molten salt fuel liquid of the primary circuit can be between 550 and 750° C.

Preferably, the secondary fluid circulating in the exchanger or exchangers is based on a mixture of molten salts NaCl—MgCl₂, NaCl—MgCl₂—KCl or even NaCl—MgCl₂—KCl—ZnCl₂.

Advantageously, the temperature of the secondary fluid at the input of the exchanger or exchangers is of the order of 500° C. while its temperature at the output of the exchanger or exchangers is of the order of 600° C.

The power of the nuclear reactor is advantageously between 10 and 300 MWth, which corresponds to a power range sought for reactors of AMR type.

Thus, the invention consists essentially in producing a molten salt nuclear reactor of fast neutron type, with a cylindrical shell in the reactor tank, free of moderator or at the very least of a moderator making it possible to qualify a reactor as thermal neutron reactor, which makes it possible to well separate the fluidic zones between that delimited at its periphery in which the heat exchanger or exchangers between primary and secondary circuit is or are arranged and the zone inside the shell whose bottom defines the reactor core in which the chain fission nuclear reactions take place.

It is advantageously possible to arrange a single annular exchanger, that is to say with a single exchange loop with the secondary circuit.

This shell thus makes it possible to guarantee a circulation of the chloride salt and uranium/plutonium fuel primary liquid only by natural convection in the reactor tank.

Thus, when the reactor is in operation, the molten salt liquid at the cold temperature leaving the exchanger descends at the periphery of the core, changes direction at the bottom of the tank in a bottom turning zone, which can preferably be implemented by a deflector with partial toroidal section, then rise by being heated in the central part of the core. With the hot temperature that it has acquired, the molten salt liquid continues to rise to a level above the exchanger then is returned to the latter by a top turning zone, preferably implemented by a deflector with partial toroidal section.

Ultimately, a molten salt, fast neutron nuclear reactor according to the invention offers many advantages, among which can be cited:
a circulation only by natural convection for the primary circuit with the possibility of implementing one or more exchangers between primary and secondary circuits. In the case of a single exchanger, the latter is annular and extends over the circumference of the reactor tank;
a simplification of the fluidic circuits with respect to the solutions according to the state-of-the-art with, in particular, the elimination of all the pipework and pumps required in the MSFR concepts cited in the preamble;
the possibility of dimensioning a reactor tank incorporating a fuel primary circuit of reduced size, typically with a diameter less than 2 m, and an overall height less than 4 m, which renders the reactor conformal to the demands of the modular AMR reactors. Thus, a primary circuit with a reactor tank, the internal cylindrical shell and its primary/secondary exchanger according to the invention can be manufactured in the factory, transported to the site, then used in the lifetime of the reactor. During dismantling, such a circuit could be loaded entirely in a shipping cask to be treated in a suitable factory. In other words, the invention makes it possible to drastically simplify the manufacture, the deployment and the dismantling of a molten salt nuclear reactor of fast neutron type, of low and average power.

Other advantages and features of the invention will become more apparent on reading the detailed description of exemplary implementations of the invention given in an illustrative and nonlimiting manner with reference to the following figures.

### BRIEF DESCRIPTION OF THE DRAWINGS

FIG. 1 is a view derived from a simulation coupling computational fluid dynamics (CFD) and 3D neutronics, showing the circulation of the primary fluid with the field of the temperatures within a molten salt nuclear reactor, of fast neutron type according to the invention.

FIG. 2 is a longitudinal cross-sectional schematic view illustrating a bayonet tube exchanger, with its input and output manifolds, as it can be arranged in a reactor according to the invention.

FIG. 3 is a view derived from a digital simulation as according to FIG. 1 for a case of simulation of a reactor according to the invention in which the molten salt fuel liquid of the primary circuit is a mixture of NaCl, 25% UCl3, 9% PuCl3 in molar proportions as salts, with depleted uranium U235 to 0.7% atomic.

FIG. 4 is a view derived from a digital simulation as according to FIG. 1 for a case of simulation of a reactor according to the invention in which the molten salt fuel liquid of the primary circuit is a mixture of NaCl, 34% UCl3 in molar proportions, as salts with enriched uranium U235 (HALEU), in 20% atomic proportion.

FIG. 5 is a longitudinal cross-sectional schematic view of a fast neutron molten salt nuclear reactor according to the invention showing the primary, secondary and tertiary circuits.

### DETAILED DESCRIPTION

Throughout the present application, the terms “vertical”, “lower”, “upper”, “bottom”, “top”, “below” and “above” should be understood for reference with respect to a fast neutron molten salt nuclear reactor, as it is planned in vertical configuration of operation according to the invention.

The terms “primary fluid”, “secondary fluid” and “tertiary fluid” are understood to mean the fluid which respectively constitutes the primary, secondary and tertiary circuits.

It is specified that the different temperatures, powers, volumes, flowrates, etc indicated are so indicated only by way of indication. For example, other temperatures can be envisaged according to the configurations notably of molten salt reactor power, molten salt fuel liquid volume, of power requirement for the application envisaged, and so on.

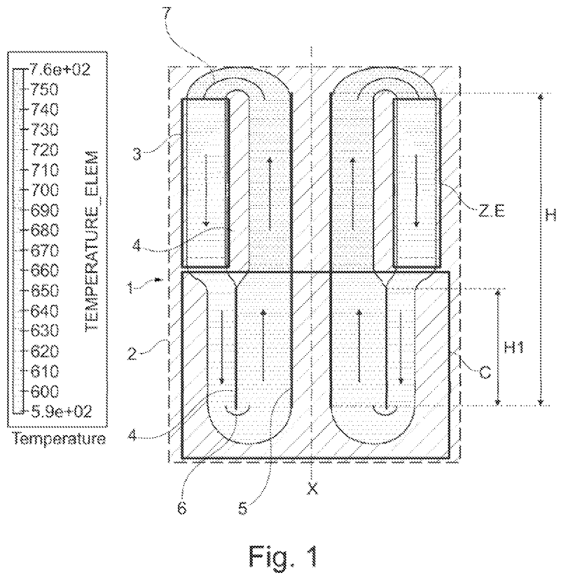

Referring to FIG. 1, a molten salt nuclear reactor 1 of fast neutron type is described, according to a primary circuit configuration according to an embodiment of the invention. This FIG. 1 is a digital simulation view obtained by coupling computational fluid dynamics (of acronym CFD) and 3D neutronics, as explained hereinbelow.

The reactor 1 with a central axis X comprises a tank 2 with jacket of metal made stainless steel, preferentially, or of a nickel-based alloy, with a thickness of the order of 10 to 20 mm, and formed by a hemispherical tank bottom and a vertical cylinder.

This reactor tank 2 internally delimits a primary circuit of fuel in liquid form in which at least one salt is molten. The interior of the tank 2 is stripped of moderator material. In other words, the molten salt fuel liquid fills and circulates inside the tank without being moderated.

A single annular heat exchanger 3 between the primary circuit of the reactor and a secondary circuit is arranged inside the reactor tank 2.

A first shell 4 in the form of at least one hollow cylinder, with a central axis that coincides with that of the reactor tank, is arranged in the reactor tank 2 to separate the interior thereof into a central zone and a peripheral zone in which the heat exchanger 3 is arranged.

The thickness of the bottom of the shell 4, in the zone of the core C, can be reduced compared to that of the top of the shell 4. As an example, for an overall height H equal to 2.5 m, the reduced height H1 of the bottom of the shell 4 is equal to 1 m.

A second shell 5 is arranged concentrically inside the first shell 4. The interior of the second shell 5 defines a space in which nuclear reaction control and/or safety bars can extend.

The shells 4, 5 can be made of stainless steel or of a nickel-based alloy.

The shells 4, 5 are advantageously fixed by suspension from the lid cap closing the reactor tank 2.

At the bottom of the reactor tank 2, below the first shell 4, is arranged a first deflector 6, in the form of a torus portion.

At the top of the reactor tank 2, above the first shell 4, is arranged a second deflector 7, also in the form of a torus portion.

As symbolised by the arrows in FIG. 1, with the shells 4, 5 and the deflectors 6, 7 as arranged, when the reactor is in operation, the molten salt fuel liquid circulates only by natural convection according to a loop from the bottom of the central zone defining the reactor core C in which the fission reactions take place, from which it rises by heating to the top of the central zone between the shells 4 and 5 where it is deflected by the deflector 7 to the top of the peripheral zone to pass through the exchanger 3 then descends to the bottom of the peripheral zone where it is deflected by the deflector 7 to the core of the reactor C.

The shell 5 makes it possible to guide the fuel liquid which rises between the two zones where it is deflected, that is to say in the central zone of the reactor from the zone of deflection by the deflector 6 in passing through the core C to the zone of deflection by the deflector 7.

The deflectors 6, 7, by their forms and their arrangement, each make it possible to distribute the flowrate of the deflected molten salt fuel liquid.

As shown in FIG. 1, the thickness of the part of the first shell arranged above the exchanger 4 can be greater than that of its part arranged below the exchanger, that is to say at the core C.

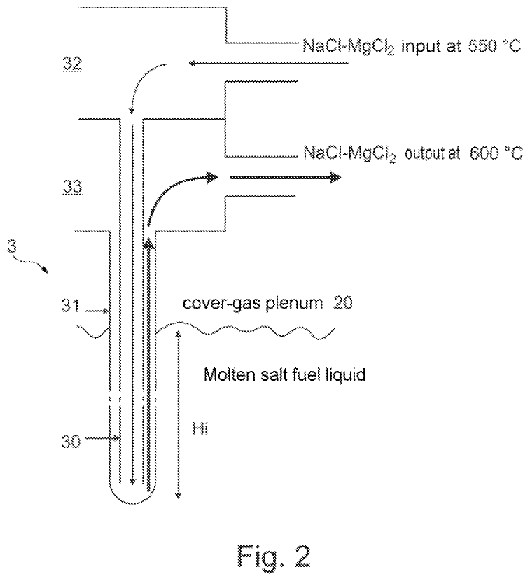

As illustrated in FIG. 2, the reactor tank 2 comprises a plenum, usually called cover-gas plenum 20, filled with an inert gas, such as argon, above the molten salt fuel liquid.

The single heat exchanger 3 comprises a bundle of bayonet tubes defining the exchange part with the secondary circuit.

As illustrated in FIG. 2, each bayonet tube comprises a hollow tube 30 each emerging inside a blind tube 31.

Each tube 30, 31 is dipped substantially vertically in the molten salt fuel liquid according to a partial immersion height Hi.

Each emerging hollow tube 30 is linked to an input manifold 32 while each blind tube is linked to an output manifold 33 of the secondary fluid.

The input manifold 32 and output manifold 33 of the secondary fluid are advantageously arranged in the cover-gas plenum 20.

The inventors have performed simulations of dimensioning of a reactor 1, such as that shown in FIG. 1.

For a given salt composition, the inventors have adapted the methodology for design of the primary circuit of this type as follows:
Step i/: determination of the minimum and maximum temperatures acceptable in the molten salt of the fuel liquid. The minimum temperature is generally imposed to limit the risk of solidification of the salt, while the maximum one is imposed by the maximum temperatures admissible by the materials.
Step ii/: from the thermal power targeted for the reactor 1, determination of the flowrate of the primary circuit necessary to observe the temperature deviation imposed in step i/.
Step iii/: for a targeted primary circuit height, imposed for example by constraints of transportability of the reactor tank 2, determination of the horizontal passage sections at the core C and the exchanger 3 which are necessary to obtain the flowrate of the primary circuit targeted in step ii/.
Step iv/: the horizontal section of the core C being known, determination of the core C height necessary to guarantee its criticality. For high power cores, i.e. of large section, a reduced height can prove sufficient. On the other hand, a low demanded power can lead to a core of more elongate form.

In practice, the inventors have performed pre-dimensioning calculations on the primary circuit of a reactor as shown in FIG. 1 based on computational simulation tools coupling CFD thermo-hydraulics, in order to determine the local speed and temperature fields and the 3D neutronics, in order to determine that the criticality and the spatial distribution of the power have been achieved.

The CFD computational simulation software can be that known as TrioCFD. This code TrioCFD was developed by the Applicant and validated to effectively deal with various physical problems, such as turbulent flows, fluid/solid coupling, polyphasic flows or flows in a porous medium: [3].

The 3D neutron simulation software can be that known as ERANOS. This ERANOS software was developed in the 1970s and validated in order to supply an appropriate scientific calculation tool for reliable neutron calculations of the sodium-cooled fast neutron reactor cores: [4].

The ERANOS software was used with the library of European nuclear data JEFF3.1.1 supplied by the Nuclear Energy Agency NEA.

The publication [5] is an example of dimensioning by CFD thermo-hydraulic coupling with 3D neutronics.

Repeated iterations are necessary to achieve an optimal design.

The dimensional, temperature and power, and molten salt fuel liquid characteristics obtained are as follows:
dimensions: diameter of tank 2 being between 1.5 and 2 m, height of the primary circuit being between 2.5 and 4 m;
power being between 10 and 300 MWth;
operating temperature of the primary circuit between 550 and 750° ° C.;
molten salt fuel liquid of the primary circuit to be chosen from among a mixture of NaCl—UCl₃ of 25 to 30% mol-PuCl₃ of 9 to 11% mol with depleted uranium U235 at 0.7%, or a mixture of NaCl—UCl₃ at 34% mol with 20% enriched natural uranium U235.

Advantageously, the elements such as MgCl₂, minor actinide chlorides or even other elements from the periodic table of the elements will be able to be added in variable proportions.

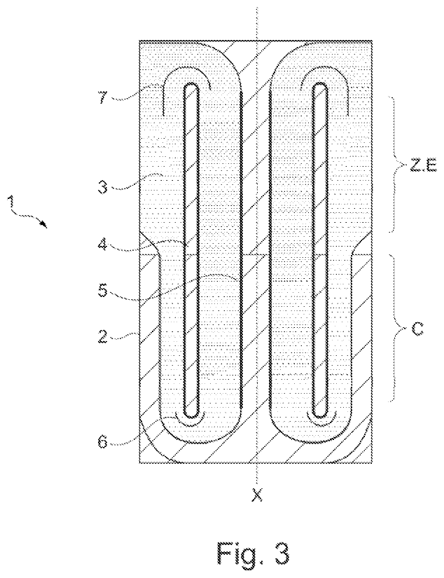

FIG. 3 illustrates a case of a reactor 1 obtained by the above-mentioned coupling computational simulation, for a fuel liquid with mixture of salts NaCl-25% UCl3-9% PuCl3 with plutonium derived from MOX. It is recalled here that MOX is a nuclear fuel composed of approximately 8.5% plutonium dioxide (PuO₂) and 91.5% depleted uranium dioxide (UO₂).

For this case, the data obtained are as follows:
outer diameter of the reactor tank 2 equal to 1.58 m,
flowrate of fuel liquid in the core equal to 1856 kg/s with a temperature deviation between input and output of the core C equal to 140° C.;
volume of dissolved salt equal to 3.55 m³ with 901 kg of fissile Pu;
effective neutron multiplication factor keff, which expresses the factor by which the number of fissions is multiplied from one generation of neutrons to the next equal to 1.005+/−0.2;
τ_{conv} equal to 1.01.

It is recalled here that τ_{conv} designates the rate of conversion which is calculated according to the following methodology:
determining, for each possible isotope of U and of Pu, its contribution to the chain reaction and expressing it in equivalent Pu-239 nuclei. For example, a U-235 nucleus has a value of approximately 0.7 Pu-239 nucleus, whereas a Pu-241 nucleus has a value of approximately 2.0;
assessing production/destruction of these isotopes to calculate the ratio between the number of equivalent Pu239 nuclei produced and the number of equivalent Pu239 nuclei destroyed.

Reference will be able to be made to the publication [6] which explains this methodology in detail.

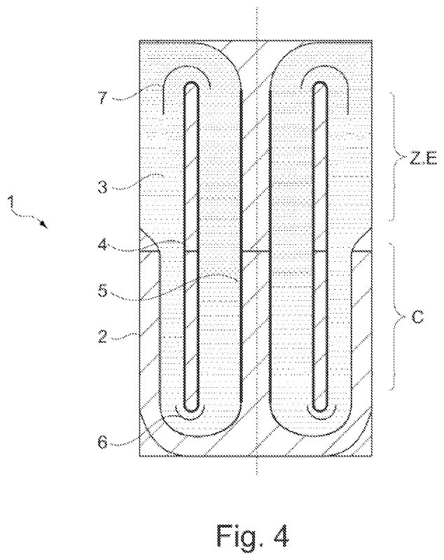

FIG. 4 illustrates a case of a reactor 1 obtained by the above-mentioned coupling computational simulation, for a fuel liquid with mixture of NaCl—UCl₃ to 34% mol with 20% enriched natural uranium U235.

For this case, the data obtained are as follows:
outer diameter of the reactor tank 2 equal to 1.58 m,
flowrate of fuel liquid in the core equal to 1750 kg/s with a temperature deviation between input and output of the core C equal to 150° C.;
volume of dissolved salt equal to 2.95 m³ with 997 kg of fissile Pu;
effective neutron multiplication factor keff, equal to 1.008+/−0.2;
τ_{conv} equal to 0.95.

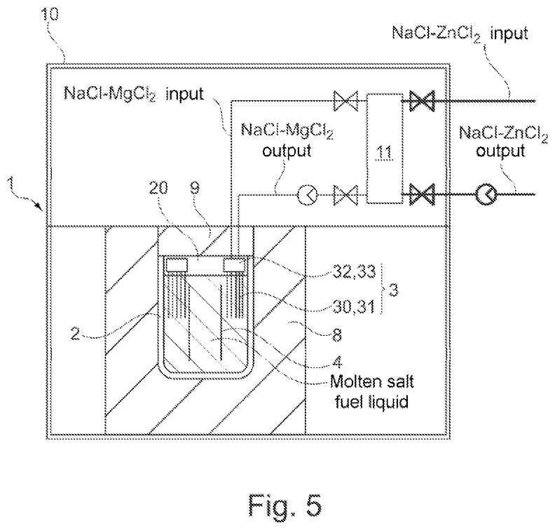

FIG. 5 illustrates an example of integration of the reactor 1 which has just been described in a reactor building 10 and the secondary and tertiary circuits.

The secondary fluid is composed of a mixture of salts NaCl—MgCl₂ which enters by forced convection into the exchanger 3 at 550° C. and leaves therefrom at 600° C.

The exchanger 11 between secondary circuit and tertiary circuit is in the reactor building 10.

The tertiary fluid is composed of a mixture of salts NaCl—ZnCl₂ which enters by forced convection into the exchanger 11 at 500° C. and leaves therefrom at 550° ° C.

The invention is not limited to the examples which have just been described; it is notably possible to combine with one another features of the examples illustrated in variants that are not illustrated.

Other variants and embodiments can be envisaged without in any way departing from the scope of the invention.

For example, other U-shaped tubes, helical tubes (with plates) can be implemented provided they have inputs and outputs towards the top and low head losses.

### LIST OF REFERENCES CITED

[1]: E. Merle-Lucotte, M. Allibert, M. Brovchenko, D. Heuer, V. Ghetta, A. Laureau, P. Rubiolo, Chapter “Introduction to the Physics of Thorium Molten Salt Fast Reactor (MSFR) Concepts”, Thorium Energy for the World, Springer International Publishing, Switzerland (2016).
[2]: Jiri Krepel et al. “Self-Sustaining Breeding in Advanced Reactors: Characterization of Selected Reactors”, Encyclopedia of Nuclear Energy 2021, Pages https://www.sciencedirect.com/science/article/pii/B9780 128197257001239?via %3Dihub 801-819.
[3]: Pierre-Emmanuel Angeli et al. “OVERVIEW OF THE TRIOCFD CODE: MAIN FEATURES, V&V PROCEDURES AND TYPICAL APPLICATIONS TO NUCLEAR ENGINEERING”. NURETH-16, Chicago, IL, Aug. 30-Sep. 4, 2015.
[4]: G. Rimpault, et al. “The ERANOS Code and data system for fast reactor neutronic analyses.” PHYSOR2002-International Conference on the New Frontiers of Nuclear Technology: Reactor Physics, Safety and High-Performance Computing, October 2002, Seoul, South Korea.
[5]: Marco Tiberga et al. “Results from a multi-physics numerical benchmark for codes dedicated to molten salt fast reactors”, Annals of Nuclear Energy 142 (2020) 107428.
[6]: A. R. Baker, R. W. Ross, “Comparison of the value of plutonium and uranium isotopes in fast reactors.” In Proc. Conf. Breeding, Economics and Safety in Large Fast Breeder Reactors (Argonne National Laboratory, 1963), pp. 329-364, ANL-6792.

1. A molten salt nuclear reactor of a fast neutron reactor type, comprising:
a reactor vessel exhibiting symmetry of revolution about a central axis, internally delimiting a primary circuit for fuel in liquid form and in which reactor vessel at least one salt is melted, an inside of the reactor vessel being free of any moderator material;
a second vessel, arranged around the reactor vessel, thereby defining a guard gap filled with an inert liquid salt.

2. The reactor of claim 1, wherein the inert liquid salt comprises NaCl, MgCl, KCl, ZnCl₂, and/or PbCl₂.

3. The reactor of claim 1, further comprising:
a heat exchanger configured to exchange heat between the primary reactor circuit and a secondary circuit and arranged inside the reactor vessel;
a first shell formed as at least one hollow cylinder of central axis coincident with that of the reactor vessel, the first shell being arranged in the reactor vessel so as to divide the interior thereof into a central zone and a peripheral zone in which the heat exchanger is arranged so that when the reactor is in operation, molten salt fuel liquid circulates via natural convection in a loop from a bottom of the central zone defining a reactor core in which a fission reactions occur, from where it rises, as a result of heating, as far as a top of the central zone where it is deflected towards a top of the peripheral zone to pass through the heat exchanger then drops back down towards a bottom of the peripheral zone where it is deflected towards the reactor core;
a neutron reflector, arranged at the periphery of the reactor core against the reactor vessel, configured to maintain neutron flux in the reactor core.

4. The reactor of claim 3,
wherein the molten salt fuel liquid of the primary circuit is a mixture of NaCl—UCl₃ and PuCl3, with depleted uranium,
wherein a first part of the first shell that is arranged above the heat exchanger(s) is a cylinder ring closed on itself, and a second part that is arranged below the heat exchanger(s) is a hollow cylinder,
wherein the neutron reflector is made of silicon carbide (SIC).

5. The reactor of claim 3,
wherein the molten salt fuel liquid of the primary circuit is a mixture of NaCl—UCl₃ with enriched (HALEU) uranium U235,
wherein the first shell is a cylinder ring closed on itself,
wherein the neutron reflector is graphite.

6. The reactor of claim 3, further comprising:
a second shell arranged concentrically inside the first shell so as to guide the rising fuel liquid between the two zones at which it is deflected.

7. The reactor of claim 6, wherein an inside of the second shell defines a space inside which nuclear-reaction control and/or safety rods extend.

8. The reactor of claim 1, wherein an outside diameter of the second vessel, filled with the inert liquid salt, is in a range of from 2.8 to 3.2 m.

9. The reactor of claim 1, wherein an inside diameter of the reactor vessel is in a range of from 1.5 to 2 m.

10. The reactor of claim 1, wherein a height of the primary circuit inside the reactor vessel is in a range of from 2.5 to 4 m.

11. The reactor of claim 1, configured such that a temperature of the molten salt fuel liquid of the primary circuit is in a range of from 600 to 750° C. when the reactor is in operation.

12. The reactor of claim 1, wherein a secondary fluid circulating in the heat exchanger(s) comprises molten NaCl—MgCl₂ or NaCl—MgCl₂—KCl or NaCl—MgCl₂—KCl—ZnCl₂.

13. The reactor of claim 12, configured such that an entry temperature of the secondary fluid entering the heat exchanger(s) is 550° C., and an exit temperature on leaving the heat exchanger(s) is 600° C.

14. The reactor of claim 1, having a power of less than 300 MWth.

15. The reactor of claim 3, wherein the molten salt fuel liquid of the primary circuit comprises the UCl₃ in a range of from 25 to 30 mol. %, based on salts.

16. The reactor of claim 3, wherein the molten salt fuel liquid of the primary circuit comprises the PuCl₃ in a range of from 5 to 30 mol. %, based on salts.

17. The reactor of claim 3, wherein the molten salt fuel liquid of the primary circuit comprises, based on salts,
the UCl₃ in a range of from 25 to 30 mol. %, and
the PuCl₃ in a range of from 5 to 30 mol. %.

18. The reactor of claim 3, wherein the molten salt fuel liquid of the primary circuit comprises the UCl₃ in 34 mol. %, based on salts.

19. The reactor of claim 3, wherein the molten salt fuel liquid of the primary circuit comprises the enriched (HALEU) uranium U235 in a range of from 5 to 20 mol. %.

20. The reactor of claim 3, wherein the molten salt fuel liquid of the primary circuit comprises
the UCl₃ in 34 mol. %, based on salts, and
the enriched (HALEU) uranium U235 in a range of from 5 to 20 mol. %.
